(19) United States
(12) Patent Application Publication
(10) Pub. No.: US 2017/0063517 A1
(43) Pub. Date: Mar. 2, 2017

(54) FULL-DUPLEX RADIO RECEIVER NETWORK DEVICE AND FULL-DUPLEX RADIO DATA TRANSMISSION METHOD THEREOF

(71) Applicant: Institute For Information Industry, Taipei (TW)

(72) Inventors: Shu-Han LIAO, New Taipei City (TW); Jian-Cheng LI, New Taipei City (TW); Yi-Hsueh TSAI, New Taipei City (TW); Feng-Ming YANG, Taipei City (TW)

(21) Appl. No.: 15/230,341

(22) Filed: Aug. 5, 2016

Related U.S. Application Data
(60) Provisional application No. 62/209,971, filed on Aug. 26, 2015.

(51) Int. Cl. H04L 5/14; H04W 74/08

(52) U.S. Cl. CPC H04L 5/1461; H04W 74/0808; H04L 5/14

(57) ABSTRACT

An FUR receiver network device and an FDR data transmission method thereof are provided. The receiver network device is used in a network system, and the network system further includes a transmitter network device. There is an FDR connection between the receiver network device and the transmitter network device in an unlicensed band. The receiver network device receives a radio signal in the unlicensed band and retrieves a transmitter signal of the transmitter network device from the radio signal. The receiver network device calculates a differential signal between the radio signal and the transmitter signal and determines whether a signal energy of the differential signal is less than a threshold. If positive, the receiver network device and the transmitter network device perform an FDR data transmission therebetween.

### PRIORITY

This application claims priority to U.S. Provisional Patent Application No. 62/209,971 filed on Aug. 26, 2015, which is hereby incorporated herein by reference in its entirety.

### FIELD

The present invention relates to a full-duplex radio (FDR) receiver network device and an FDR data transmission method thereof. More specifically, the FUR receiver network device of the present invention and the FDR data transmission method thereof are used for FDR data transmission having the Listen Before Talk (LBT) protocol.

### BACKGROUND

In the conventional network technology, when a network device is to transmit data in an unlicensed band, the network device will first perform the Listen Before Talk (LBT) protocol so as to determine whether other devices are using the unlicensed band. In this way, signal interference can be prevented from occurring. Under the time-division duplex (TDD) network architecture, a transmitter device and a receiver device achieve data transmission mainly in a time-division manner, so signals of one of the transmitter device and the receiver device will not be detected when the other one of the transmitter device and the receiver device is performing the LBT protocol. In this way, when the LBT protocol is performed under the TDD network architecture, logic misjudgment will not be generated.

Similarly, under the frequency-division duplex (FDD) network architecture, the transmitter device and the receiver device perform the data transmission mainly in a frequency-division manner, so signals of one of the transmitter device and the receiver device also will not be detected when the other one of the transmitter device and the receiver device is performing the LBT protocol. Similarly, when the LBT protocol is performed under the FDD network architecture, logic misjudgment also will not be generated.

However, under the full-duplex radio (FDR) network architecture, the transmitter device and the receiver device perform data transmission at the same time and the same frequency. Therefore, when the transmitter device is transmitting a downlink signal to the receiver device, the receiver device performs the LBT protocol and determines a band is not idle because the downlink signal of the transmitter device in the same band is detected by the receiver device, and thus the receiver device will not transmit an uplink signal to the transmitter device. Because of this, the performance of the FDR network is greatly compromised.

Accordingly, an urgent need exists in the art to overcome the drawback occurring when the LBT protocol is performed under the FDR network architecture so as to improve the network resource utilization efficiency.

### SUMMARY

A primary objective of the present invention is to provide a full-duplex radio (FDR) data transmission method for a receiver network device. The receiver network device is used in a network system, and the network system further comprises a transmitter network device. The receiver network device and the transmitter network device have a connection therebetween in an unlicensed band.

The disclosure includes a data transmission method comprising: (a) enabling the receiver network device to receive a radio signal in the unlicensed band; (b) enabling the receiver network device to retrieve a transmitter signal of the transmitter network device from the radio signal; (c) enabling the receiver network device to calculate a differential signal between the radio signal and the transmitter signal; (d) enabling the receiver network device to determine that a signal energy of the differential signal is less than a threshold; and (e) enabling the receiver network device to perform an FDR data transmission with the transmitter network device according to the result of the step (d).

The disclosure also includes a full-duplex radio (FDR) receiver network device. The receiver network device is for use in a network system, and the network system further comprises a transmitter network device. The receiver network device and the transmitter network device have a connection therebetween in an unlicensed band. The receiver network device comprises: a transceiver, being configured to receive a radio signal in the unlicensed band; and a processor electrically connected to the transceiver, being configured to:

retrieve a transmitter signal of the transmitter network device from the radio signal; calculate a differential signal between the radio signal and the transmitter signal; determine that a signal energy of the differential signal is less than a threshold; and perform an FDR data transmission with the transmitter network device via the transceiver according to the result that the signal energy of the differential signal is less than the threshold.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1A is a schematic view of a network system according to a first embodiment of the present invention;

FIG. 1B is a block diagram of a receiver network device according to the first embodiment of the present invention;

FIG. 2A is a schematic view of a network system according to a second embodiment of the present invention;

FIG. 2B is a block diagram of a receiver network device according to the second embodiment of the present invention;

FIG. 2C to FIG. 2D are schematic views illustrating different antenna radiation patterns according to the second embodiment of the present invention;

FIG. 3A-3C are schematic views of network systems according to third embodiment of the present invention;

FIG. 4 is a flowchart diagram of an FDR data transmission method according to a fourth embodiment of the present invention;

FIG. 5 is a flowchart diagram of an FDR data transmission method according to a fifth embodiment of the present invention;

FIG. 6 is a flowchart diagram of an FDR data transmission method according to a sixth embodiment of the present invention;

FIG. 7 is a flowchart diagram of an FDR data transmission method according to a seventh embodiment of the present invention; and

FIG. 8 is a flowchart diagram of an FDR data transmission method according to an eighth embodiment of the present invention.

### DETAILED DESCRIPTION

In the following description, the present invention will be explained with reference to certain example embodiments thereof. However, these example embodiments are not intended to limit the present invention to any environment, example, embodiment, applications or implementations described in these example embodiments. Therefore, description of these example embodiments is only for purpose of illustration rather than to limit the present invention.

In the following example embodiments and the attached drawings, elements unrelated to the present invention are omitted from depiction; and dimensional relationships among individual elements in the attached drawings are illustrated only for ease of understanding, but not to limit the actual scale.

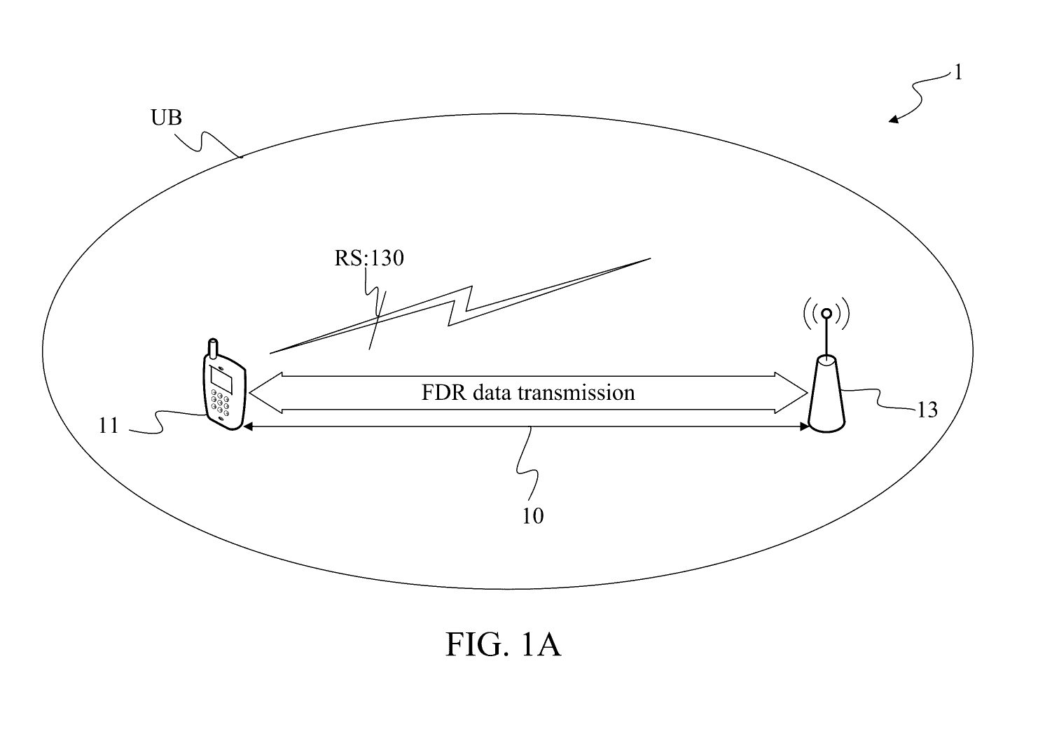

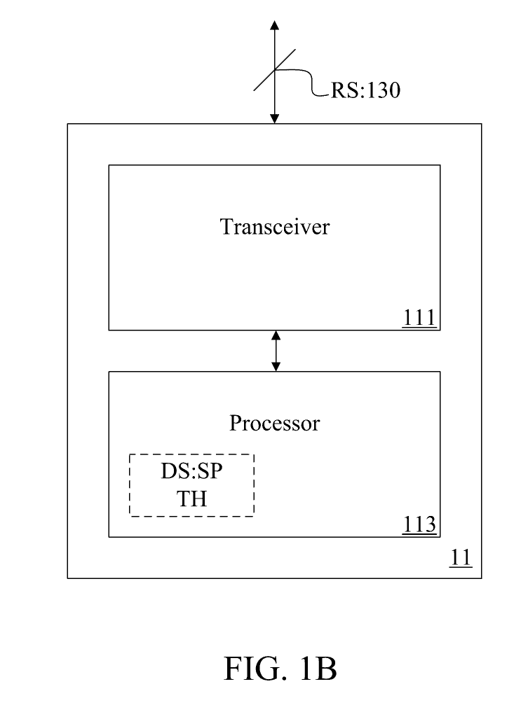

Please refer to FIG. 1A to FIG. 1B. FIG. 1A is a schematic view of a network system 1 according to a first embodiment of the present invention. The network system 1 comprises a receiver network device 11 and a transmitter network device 13 capable of full-duplex radio (FDR) operation, and the receiver network device 11 and the transmitter network device 13 have a connection 10 therebetween in an unlicensed band UB. FIG. 1B is a block diagram of the receiver network device 11 according to the first embodiment of the present invention, and the receiver network device 11 comprises a transceiver 111 and a processor 113 that are electrically connected with each other. The interaction process of the network system 1 and the devices thereof will be further described hereinafter.

First, as shown in FIG. 1A, a transceiver 113 of the receiver network device 11 receives a radio signal RS in the unlicensed band UB. In this case, the radio signal RS may include signals transmitted by devices other than the transmitter device 13. Next, since the FDR transmission needs to be performed between the receiver network device 11 and the transmitter network device 13, to prevent the receiver network device 11 from logically misjudging that the transmitter network device 13 occupies the unlicensed band UB and thereby causing the failure of the FDR transmission therebetween when the receiver network device 11 is performing the LBT protocol, the receiver network device 11 needs to first exclude the signal of the transmitter network device 13.

Specifically, the processor 113 of the receiver network device 11 retrieves a transmitter signal 130 of the transmitter network device 13 from the radio signal RS, and further calculates a differential signal DS between the radio signal RS and the transmitter signal 130. In this way, it may be determined preliminarily whether there are other possible signals in addition to the transmitter signal 130 in the radio signal RS through the differential signal DS.

Thereafter, the processor 113 of the receiver network device 11 determines whether a signal energy SP of the differential signal DS is less than a threshold TH. If the determination result is no, then it means that the energy of the differential signal DS is strong enough; and in other words, it means that other devices other than the transmitter signal 130 in the radio signal RS are using the unlicensed band UB. Accordingly, the receiver network device 11 determines that the unlicensed band UB has been occupied in the LBT protocol, and thus will not transmit the FDR uplink data to the transmitter network device 13 temporarily.

On the contrary, if the signal energy SP of the differential signal DS is less than the threshold TH, then it means that the energy of the differential signal DS is relatively weak; and in other words, it means that other signal sources other than the transmitter signal 130 in the radio signal RS can be ignored. Accordingly, the receiver network device 11 determines that the unlicensed band UB is not occupied in the LBT protocol, and thus the processor 113 of the receiver network device 11 performs the FDR data transmission with the transmitter network device via the transceiver 111.

It shall be particularly appreciated that, in the aforesaid embodiments, the technology by which the processor 113 retrieves the transmitter signal 130 from the radio signal RS may be mainly achieved by the technology of decoding and reconstructing a detection signal or by a feature signal predefined by the receiver device 11 and the transmitter device 13.

In the implementation where the detection signal is decoded and reconstructed, after the transceiver 111 of the receiver network device 11 receives the radio signal RS, the processor 113 may detect a service signal (not shown) of the transmitter network device 13 from the radio signal RS. In this case, because the processor 113 of the receiver network device 11 only knows that the service signal belongs to the transmitter network device 13 but does not know exactly the content of the service signal, the processor 113 needs to decode the service signal and then reconstruct the decoded service signal subsequently. At this point, the reconstructed service signal is the transmitter signal 130 of the aforesaid embodiments.

Additionally, in the implementation where the feature signal is predefined, after the transceiver 111 of the receiver network device 11 receives the radio signal RS, the processor 113 may detect a feature signal (not shown) of the transmitter network device 13 from the radio signal RS. In this case, since the feature signal is the signal predefined by the receiver network device 11 and the transmitter network device 13, the processor 113 can directly generate the transmitter signal 130 after the feature signal is detected.

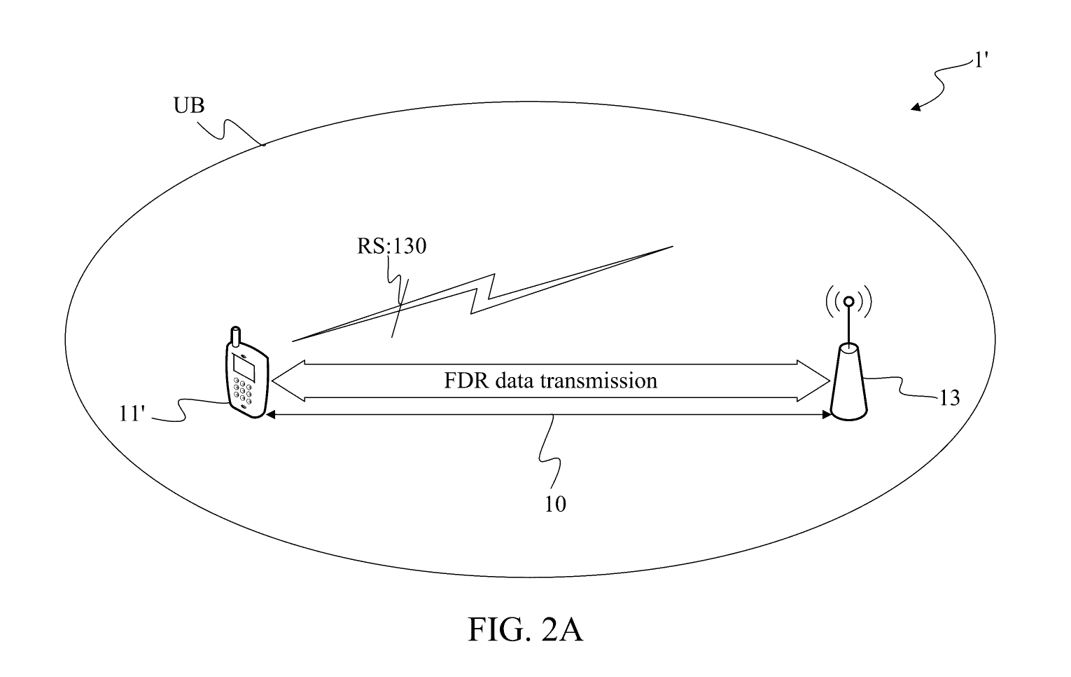

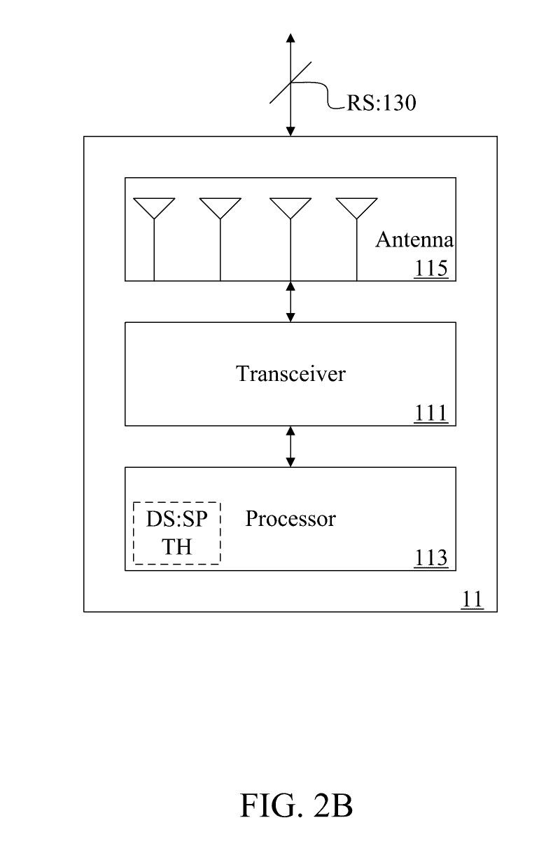

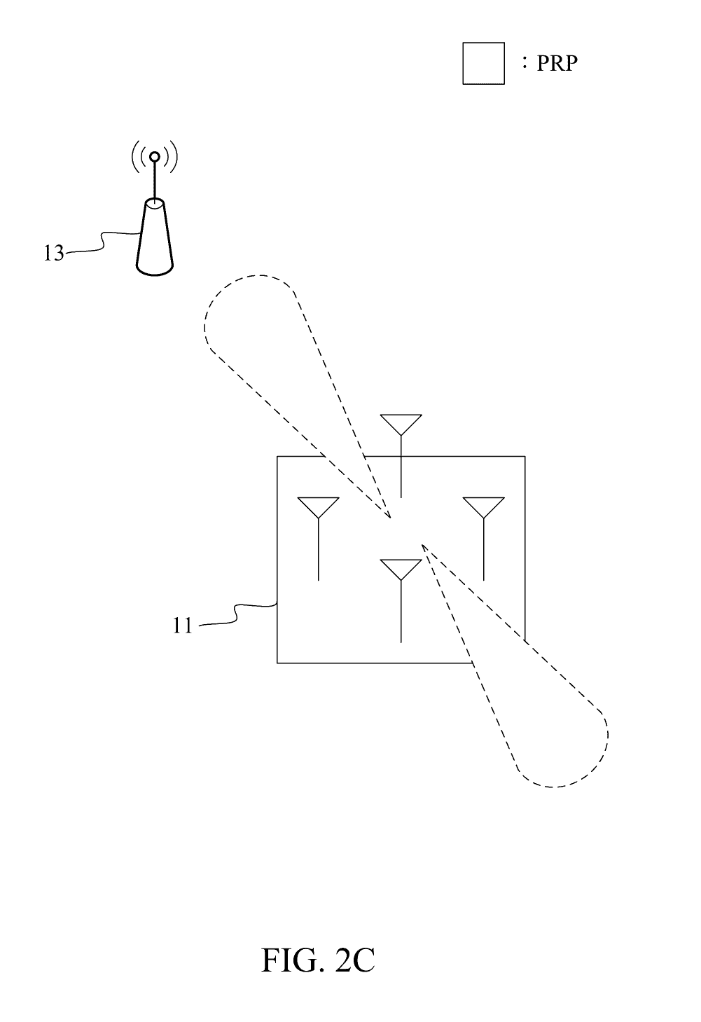

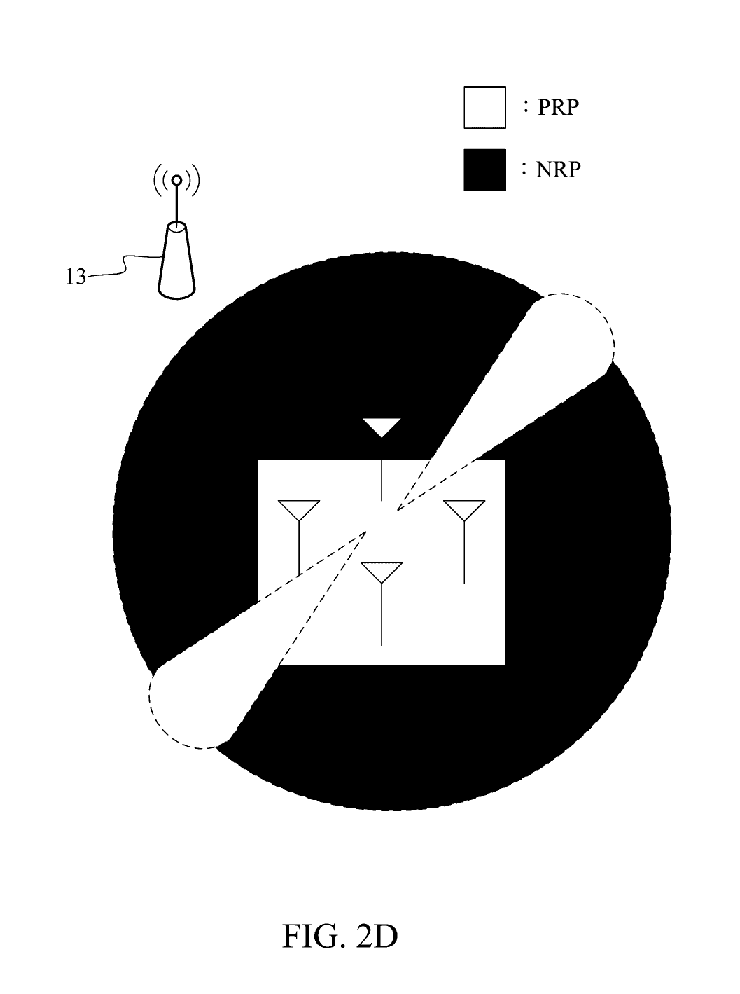

Please refer to FIG. 2A to FIG. 2D. FIG. 2A is a schematic view of a network system 1′ according to a second embodiment of the present invention. FIG. 2B is a block diagram of a receiver network device 11′ according to the second embodiment of the present invention, and the receiver network device 11′ further comprises at least one antenna 115. FIG. 2C to FIG. 2D are schematic views illustrating different antenna radiation patterns according to the second embodiment of the present invention. The architecture of the second embodiment is similar to that of the first embodiment, so elements labeled by the same reference numbers also have the same function and thus will not be further described herein. The second embodiment mainly illustrates how the receiver network device retrieves the signal by virtue of the configuration of the antenna.

In detail, referring to FIG. 2C, the receiver network device 11′ comprises at least one antenna 115, so the receiver network device 11′ can use the array antenna and the beamforming technology to form a peak radiation pattern PRP and directs the peak radiation pattern PRP towards the transmitter network device 13. In this way, the processor 113 of the receiver network device 11′ can determine the signal mainly transmitted from the transmitter network device 13 according to the signal received by the at least one antenna 115, and accordingly retrieves the transmitter signal 130 of the transmitter network device 13 from the radio signal RS.

On the other hand, referring to FIG. 2D, the receiver network device 11′ may also form a null radiation pattern and direct the null radiation pattern towards the transmitter network device 13 by excluding the peak radiation pattern (and the extended angle thereof). In this way, the processor 113 of the receiver network device 11′ can similarly infer the signal transmitted from the transmitter network device 13 reversely according to the signal received by the at least one antenna 115, and accordingly retrieves the transmitter signal 130 of the transmitter network device 13 from the radio signal RS.

It shall be particularly appreciated that, the present invention mainly emphasizes how to retrieve the transmitter signal 130 of the transmitter network device 13 from the radio signal RS, so the technology of using the beamforming and the array antenna to form the radiation pattern as described above and accordingly generating the signal content at the radiation pattern direction is the common technology means in the art, and thus the operation details thereof will not be further described herein.

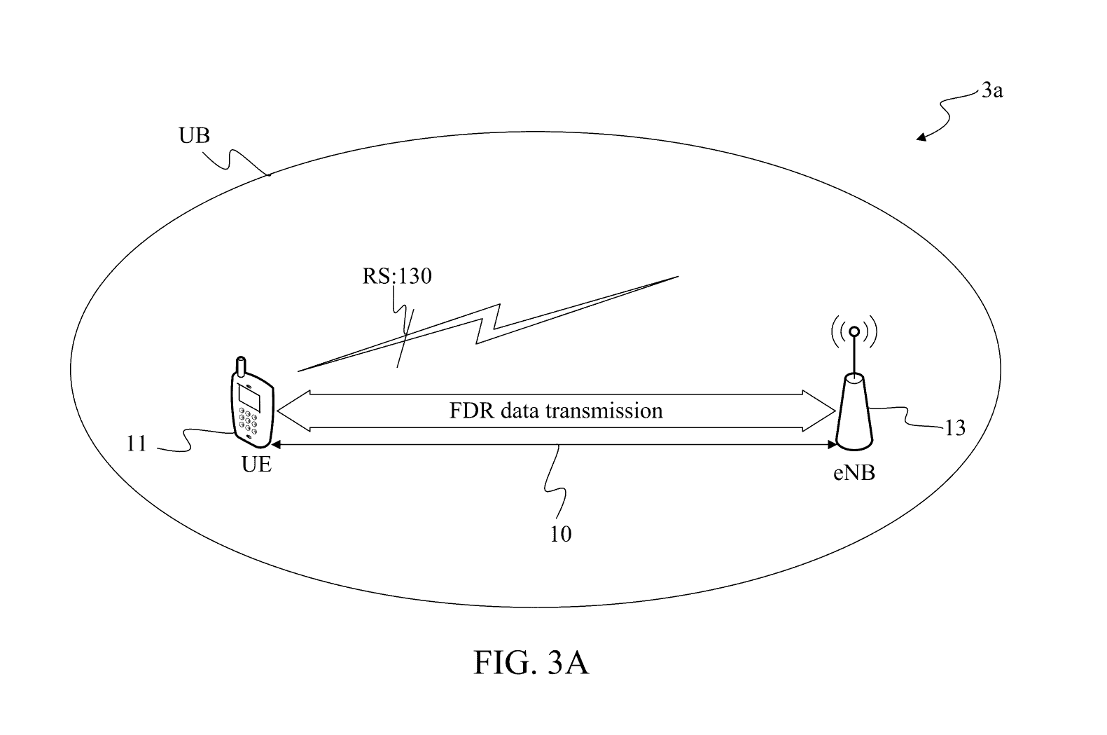

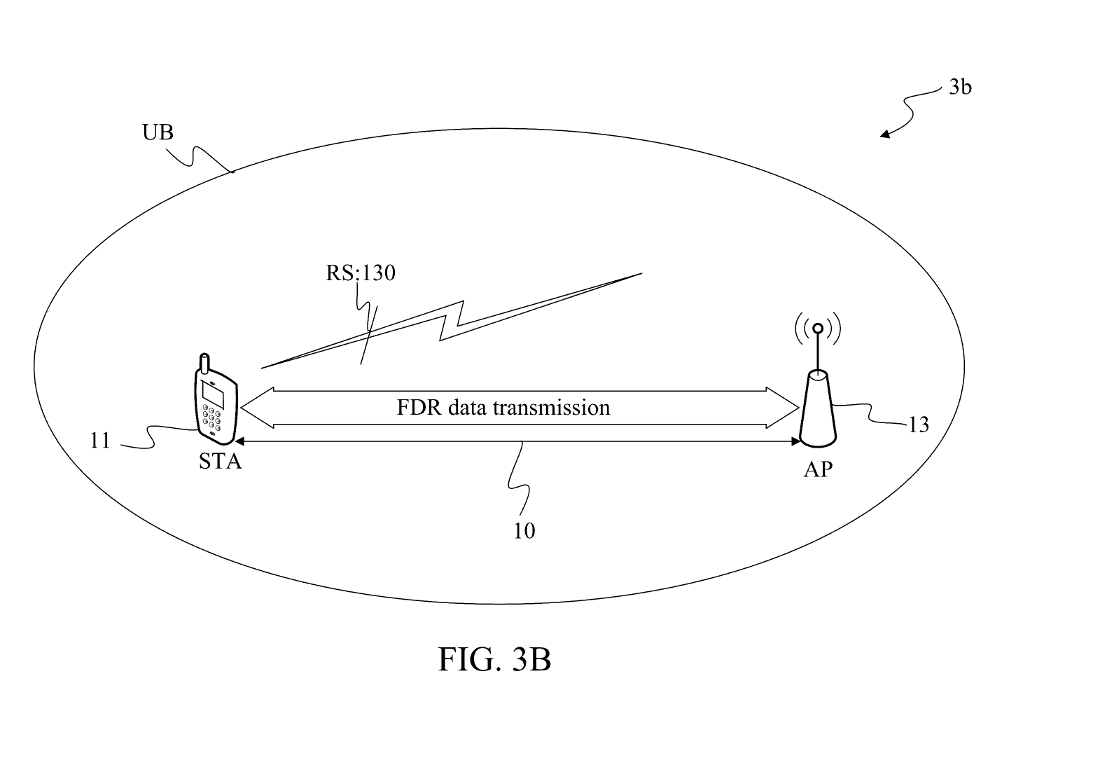

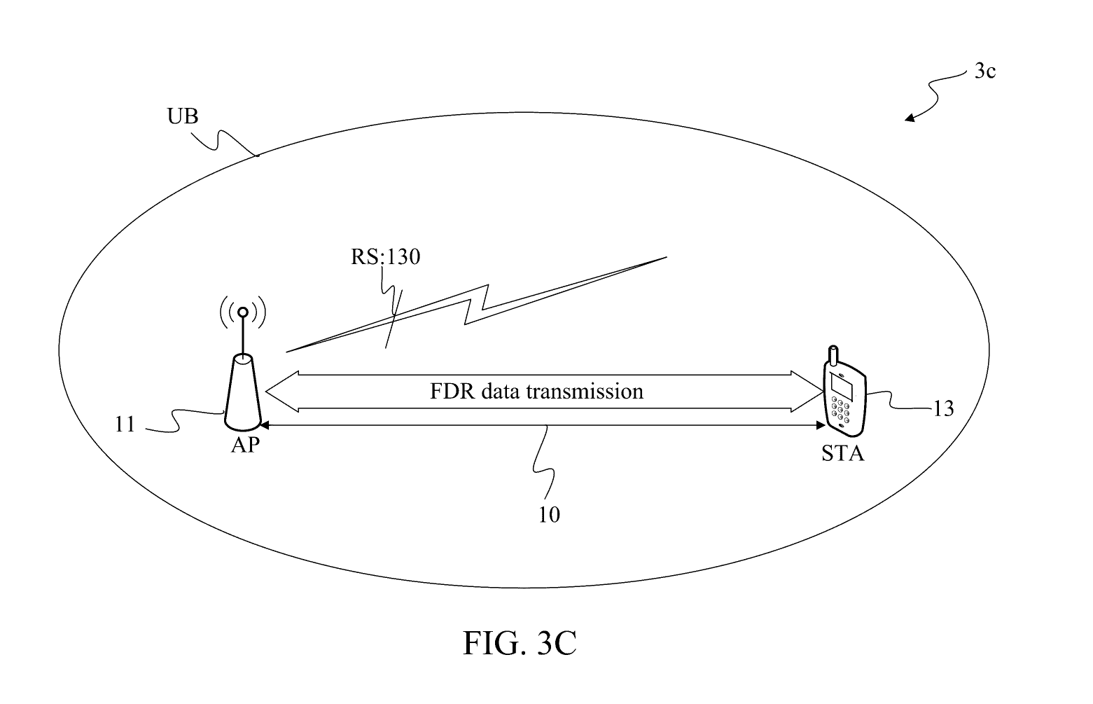

Referring to FIG. 3A to FIG. 3C, there are shown schematic views of network systems 3a to 3c according to a third embodiment of the present invention. The network system 3a is a 3GPP (3^{rd} Generation Partnership Project) network system, the transmitter network device 13 is an eNB (Evolved Node B, also known as E-UTRAN Node B), and the receiver network device 11 is a UE (user equipment).

Additionally, the network systems 3b to 3c are Wi-Fi network systems. In the network system 3b, the transmitter network device 13 is an access point, and the receiver network device 11 is a mobile station. On the other hand, because the transmitter and the receiver have the same function and play the same role in the Wi-Fi network system, the receiver network device 11 may also be the access point and the transmitter network device 13 may be the mobile station as shown in the network system 3c.

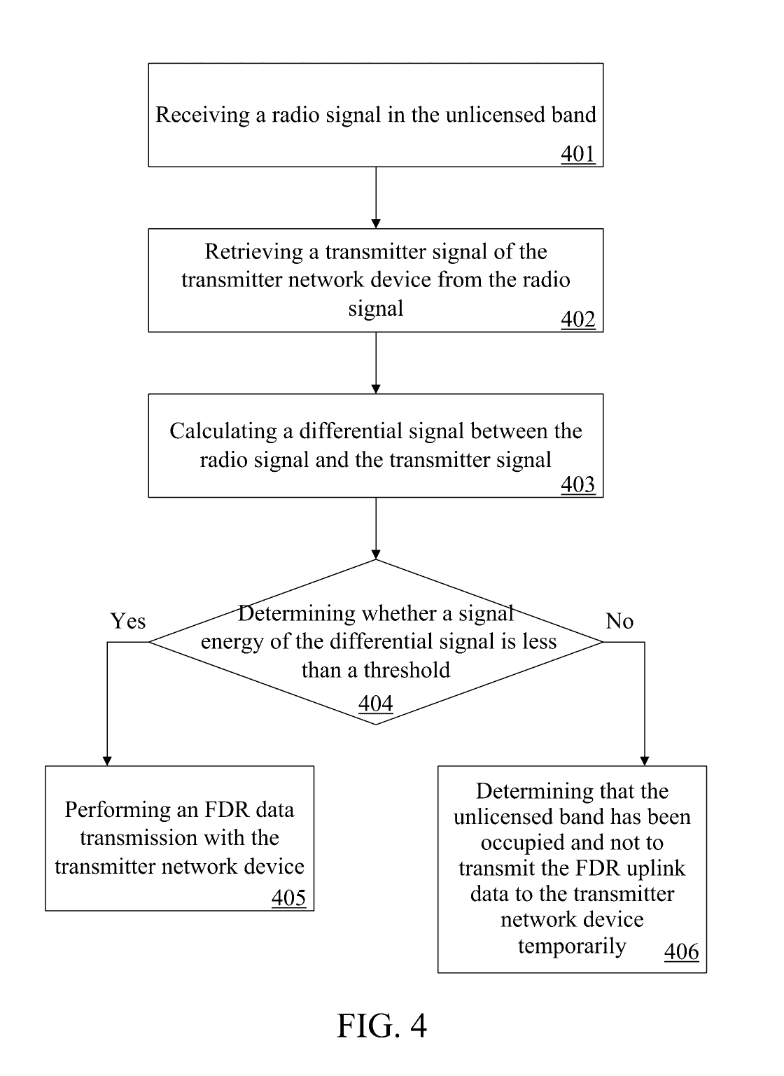

A fourth embodiment of the present invention is an FDR data transmission method, and a flowchart diagram thereof is as shown in FIG. 4. The method of the fourth embodiment is for use in a receiver network device (e.g., the receiver network device of the aforesaid embodiments), the receiver network device is used in a network system, the network system further comprises a transmitter network device, and the receiver network device and the transmitter network device have a connection therebetween in an unlicensed band. Detailed steps of the fourth embodiment are as follows.

First, step 401 is executed to enable the receiver network device to receive a radio signal in the unlicensed band. Step 402 is executed to enable the receiver network device to retrieve a transmitter signal of the transmitter network device from the radio signal. Step 403 is executed to enable the receiver network device to calculate a differential signal between the radio signal and the transmitter signal.

Next, step 404 is executed to enable the receiver network device to determine whether a signal energy of the differential signal is less than a threshold. If the determination result is yes, then step 405 is executed to enable the receiver network device to perform an FDR data transmission with the transmitter network device. If the determination result is no, then step 406 is executed to enable the receiver network device to determine that the unlicensed band has been occupied and not to transmit the FDR uplink data to the transmitter network device temporarily.

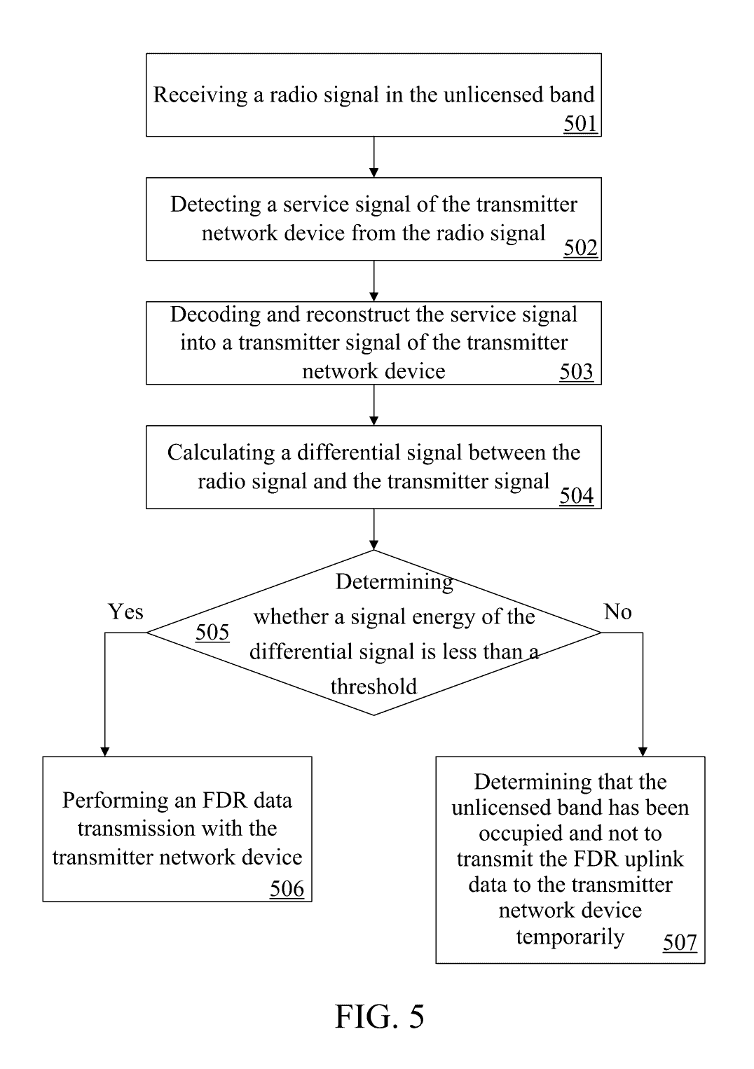

A fifth embodiment of the present invention is an FDR data transmission method, and a flowchart diagram thereof is as shown in FIG. 5. The method of the fifth embodiment is for use in a receiver network device (e.g., the receiver network device of the aforesaid embodiments), the receiver network device is used in a network system, the network system further comprises a transmitter network device, and the receiver network device and the transmitter network device have a connection therebetween in an unlicensed band. Detailed steps of the fifth embodiment are as follows.

First, step 501 is executed to enable the receiver network device to receive a radio signal in the unlicensed band. Step 502 is executed to enable the receiver network device to detect a service signal of the transmitter network device from the radio signal. Step 503 is executed to enable the receiver network device to decode and reconstruct the service signal into a transmitter signal of the transmitter network device. Step 504 is executed to enable the receiver network device to calculate a differential signal between the radio signal and the transmitter signal.

Next, step 505 is executed to enable the receiver network device to determine whether a signal energy of the differential signal is less than a threshold. If the determination result is yes, then step 506 is executed to enable the receiver network device to perform an FDR data transmission with the transmitter network device. If the determination result is no, then step 507 is executed to enable the receiver network device to determine that the unlicensed band has been occupied and not to transmit the FDR uplink data to the transmitter network device temporarily.

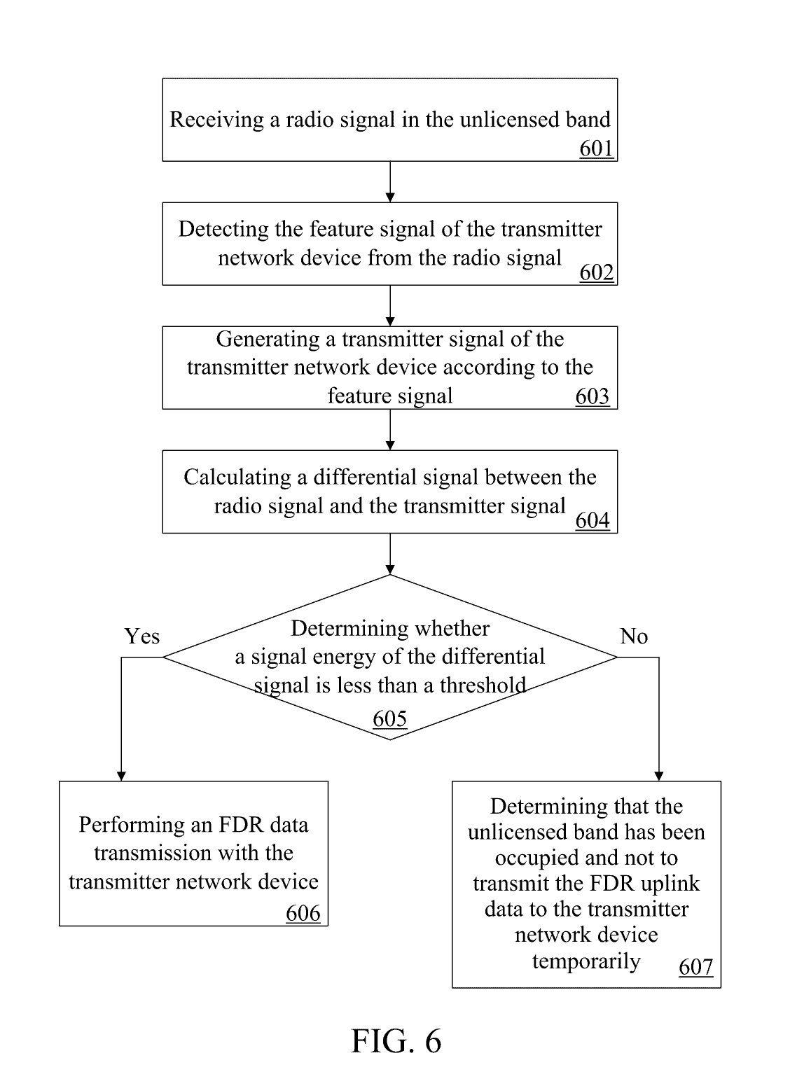

A sixth embodiment of the present invention is an FDR data transmission method, and a flowchart diagram thereof is as shown in FIG. 6. The method of the sixth embodiment is for use in a receiver network device (e.g., the receiver network device of the aforesaid embodiments), the receiver network device is used in a network system, the network system further comprises a transmitter network device, and the receiver network device and the transmitter network device have a connection therebetween in an unlicensed band and define a feature signal therebetween. Detailed steps of the sixth embodiment are as follows.

First, step 601 is executed to enable the receiver network device to receive a radio signal in the unlicensed band. Step 602 is executed to enable the receiver network device to detect the feature signal of the transmitter network device from the radio signal. Step 603 is executed to enable the receiver network device to generate a transmitter signal of the transmitter network device according to the feature signal. Step 604 is executed to enable the receiver network device to calculate a differential signal between the radio signal and the transmitter signal.

Next, step 605 is executed to enable the receiver network device to determine whether a signal energy of the differential signal is less than a threshold. If the determination result is yes, then step 606 is executed to enable the receiver network device to perform an FDR data transmission with the transmitter network device. If the determination result is no, then step 607 is executed to enable the receiver network device to determine that the unlicensed band has been occupied and not to transmit the FDR uplink data to the transmitter network device temporarily.

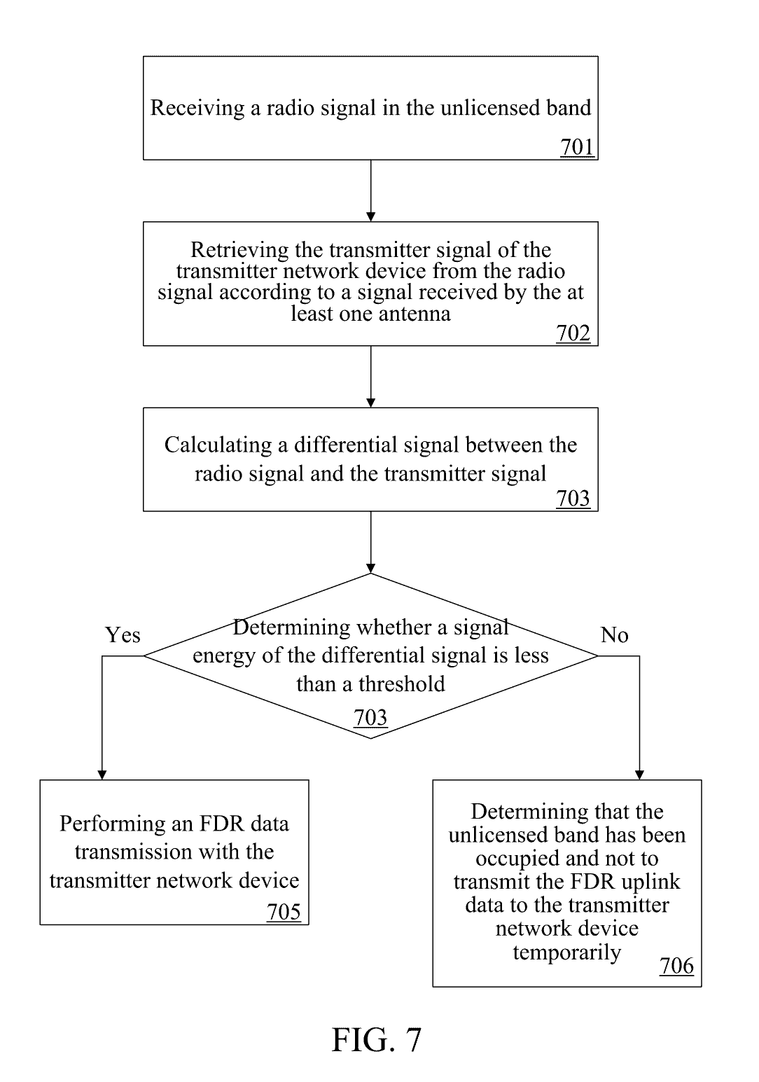

A seventh embodiment of the present invention is an FDR data transmission method, and a flowchart diagram thereof is as shown in FIG. 7. The method of the seventh embodiment is for use in a receiver network device (e.g., the receiver network device of the aforesaid embodiments), the receiver network device is used in a network system, the network system further comprises a transmitter network device, and the receiver network device and the transmitter network device have a connection therebetween in an unlicensed band. The receiver network device has at least one antenna, and a peak radiation pattern of the at least one antenna is directed towards the transmitter network device. Detailed steps of the seventh embodiment are as follows.

First, step 701 is executed to enable the receiver network device to receive a radio signal in the unlicensed band. Step 702 is executed to enable the receiver network device to retrieve the transmitter signal of the transmitter network device from the radio signal according to a signal received by the at least one antenna. Step 703 is executed to enable the receiver network device to calculate a differential signal between the radio signal and the transmitter signal.

Next, step 704 is executed to enable the receiver network device to determine whether a signal energy of the differential signal is less than a threshold. If the determination result is yes, then step 705 is executed to enable the receiver network device to perform an FDR data transmission with the transmitter network device. If the determination result is no, then step 706 is executed to enable the receiver network device to determine that the unlicensed band has been occupied and not to transmit the FDR uplink data to the transmitter network device temporarily.

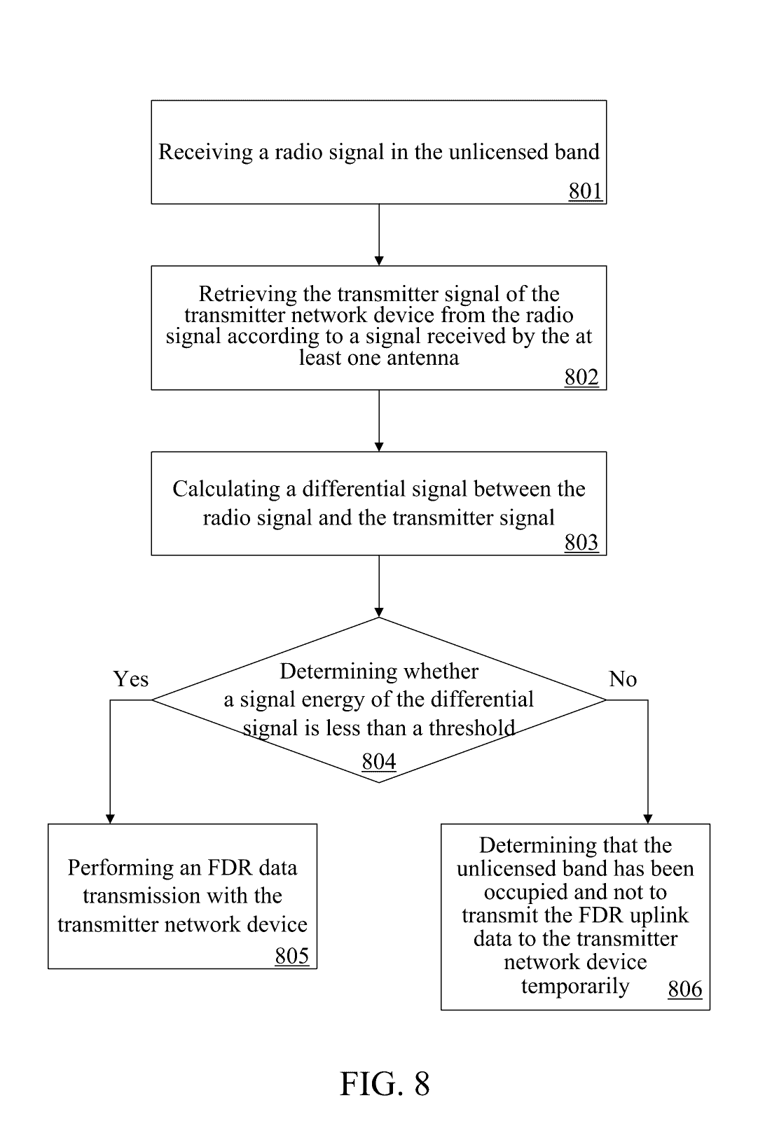

An eighth embodiment of the present invention is an FDR data transmission method, and a flowchart diagram thereof is as shown in FIG. 8. The method of the eighth embodiment is for use in a receiver network device (e.g., the receiver network device of the aforesaid embodiments), the receiver network device is used in a network system, the network system further comprises a transmitter network device, and the receiver network device and the transmitter network device have a connection therebetween in an unlicensed band. The receiver network device has at least one antenna, and a null radiation pattern of the at least one antenna is directed towards the transmitter network device. Detailed steps of the eighth embodiment are as follows.

First, step 801 is executed to enable the receiver network device to receive a radio signal in the unlicensed band. Step 802 is executed to enable the receiver network device to retrieve the transmitter signal of the transmitter network device from the radio signal according to a signal received by the at least one antenna. Step 803 is executed to enable the receiver network device to calculate a differential signal between the radio signal and the transmitter signal.

Next, step 804 is executed to enable the receiver network device to determine whether a signal energy of the differential signal is less than a threshold. If the determination result is yes, then step 805 is executed to enable the receiver network device to perform an FDR data transmission with the transmitter network device. If the determination result is no, then step 806 is executed to enable the receiver network device to determine that the unlicensed band has been occupied and not to transmit the FDR uplink data to the transmitter network device temporarily.

According to the above descriptions, the full-duplex radio (FDR) receiver network device and the FDR data transmission method thereof provided according to the present invention can mainly exclude the signal of the corresponding transmitter network device so as to prevent the receiver network device from logically misjudging that the transmitter network device occupies the unlicensed band. In this way, the FDR data transmission can be accomplished correctly when the LBT protocol is performed, thereby overcoming the drawback of the prior art and improving the network resource utilization efficiency.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A full-duplex radio (FDR) data transmission method for a receiver network device, the receiver network device being used in a network system, the network system further comprising a transmitter network device, and the receiver network device and the transmitter network device having a connection therebetween in an unlicensed band, the data transmission method comprising:
(a) the receiver network device receiving a radio signal in the unlicensed band;
(b) the receiver network device retrieving a transmitter signal of the transmitter network device from the radio signal;
(c) the receiver network device calculating a differential signal between the radio signal and the transmitter signal;
(d) the receiver network device determining that a signal energy of the differential signal is less than a threshold; and
(e) the receiver network device performing an FDR data transmission with the transmitter network device according to the result of the step (d).

2. The FDR data transmission method of claim 1, wherein the step (b) further comprises:
(b1) the receiver network device detecting a service signal of the transmitter network device from the radio signal; and
(b2) the receiver network device decoding and reconstruct the service signal into the transmitter signal.

3. The FDR data transmission method of claim 1, wherein a feature signal is defined between the receiver network device and the transmitter network device, and the step (b) further comprises:
(b1) the receiver network device detecting the feature signal of the transmitter network device from the radio signal; and
(b2) the receiver network device generating the transmitter signal according to the feature signal.

4. The FDR data transmission method of claim 1, wherein the receiver network device has at least one antenna, a peak radiation pattern of the at least one antenna is directed towards the transmitter network device, and the step (b) further comprises:
(b1) the receiver network device retrieving the transmitter signal of the transmitter network device from the radio signal according to a signal received by the at least one antenna.

5. The FDR data transmission method of claim 1, wherein the receiver network device has at least one antenna, a null radiation pattern of the at least one antenna is directed towards the transmitter network device, and the step (b) further comprises:
(b1) the receiver network device retrieving the transmitter signal of the transmitter network device from the radio signal according to a signal received by the at least one antenna.

6. The FDR data transmission method of claim 1, wherein the network system is a 3GPP network system, the transmitter network device is an eNB, and the receiver network device is a UE.

7. The FDR data transmission method of claim 1, wherein the network system is a Wi-Fi network system, the transmitter network device is an access point, and the receiver network device is a mobile station.

8. The FDR data transmission method of claim 1, wherein the network system is a Wi-Fi network system, the transmitter network device is a mobile station, and the receiver network device is an access point.

9. A full-duplex radio (FDR) receiver network device for use in a network system, the network system further comprising a transmitter network device, and the receiver network device and the transmitter network device having a connection therebetween in an unlicensed band, the receiver network device comprising:
a transceiver, being configured to receive a radio signal in the unlicensed band; and
a processor electrically connected to the transceiver, being configured to:
retrieve a transmitter signal of the transmitter network device from the radio signal;
calculate a differential signal between the radio signal and the transmitter signal;
determine that a signal energy of the differential signal is less than a threshold; and
perform an FDR data transmission with the transmitter network device via the transceiver according to the result that the signal energy of the differential signal is less than the threshold.

10. The receiver network device of claim 9, wherein the processor is further configured to:
detect a service signal of the transmitter network device from the radio signal; and
decode and reconstruct the service signal into the transmitter signal.

11. The receiver network device of claim 9, wherein a feature signal is defined between the receiver network device and the transmitter network device, and the processor is further configured to:
detect the feature signal of the transmitter network device from the radio signal; and
generate the transmitter signal according to the feature signal.

12. The receiver network device of claim 9, further comprising:
at least one antenna that forms a peak radiation pattern directed towards the transmitter network device;
wherein the processor is further configured to retrieve the transmitter signal of the transmitter network device from the radio signal according to a signal received by the at least one antenna.

13. The receiver network device of claim 9, further comprising:
at least one antenna that forms a null radiation pattern directed towards the transmitter network device;
wherein the processor is further configured to retrieve the transmitter signal of the transmitter network device from the radio signal according to a signal received by the at least one antenna.

14. The receiver network device of claim 9, wherein the network system is a 3GPP network system, the transmitter network device is an eNB, and the receiver network device is a UE.

15. The receiver network device of claim 9, wherein the network system is a Wi-Fi network system, the transmitter network device is an access point, and the receiver network device is a mobile station.

16. The receiver network device of claim 9, wherein the network system is a Wi-Fi network system, the transmitter network device is a mobile station, and the receiver network device is an access point.
